(19) United States
(12) Patent Application Publication
(10) Pub. No.: US 2024/0349646 A1
(43) Pub. Date: Oct. 24, 2024

(54) AGRICULTURAL WORK MACHINE

(71) Applicant: CLAAS Selbstfahrende Erntemaschinen GmbH, Harsewinkel (DE)

(72) Inventors: Markus Hohlfeld, Harsewinkel (DE); Günter Schnitger, Hunteburg (DE)

(73) Assignee: CLAAS Selbstfahrende Erntemaschinen GmbH, Harsewinkel (DE)

(21) Appl. No.: 18/644,257

(22) Filed: Apr. 24, 2024

(30) Foreign Application Priority Data
Apr. 24, 2023 (DE) 102023110350.4

(51) Int. Cl. A01D 43/08; A01D 43/14

(52) U.S. Cl. CPC A01D 43/085; A01D 43/14

(57) ABSTRACT

An agricultural work machine, such as a forage harvester, is disclosed. The agricultural work machine comprises an axle body with at least one ground engaging device arranged or positioned on the axle body, a wheel housing that comprises a fender sectionally surrounding the ground engaging device radially on the outside and a side wall, and a storage space with a functional assembly located therein being arranged or positioned on the side wall.

### CROSS REFERENCE TO RELATED APPLICATION

This application claims priority under 35 U.S.C. § 119 to German Patent Application No. DE 10 2023 110 350.4 filed Apr. 24, 2023, the entire disclosure of which is hereby incorporated by reference herein.

### TECHNICAL FIELD

The present invention relates to an agricultural work machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

EP 1 518 453 B2 discloses an agricultural work machine that is designed as a forage harvester. In particular, EP 1 518 453 B2 discloses a storage device for holding liquids or objects incorporated into the body of the agricultural work machine, thereby saving installation space. Such a storage device may, for example, be arranged or positioned at the bottom of the forage harvester or integrated into existing structures, such as body parts.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic representation of a forage harvester.

FIG. 2 illustrates a side view of a wheel housing of the forage harvester.

FIG. 3 illustrates a cross-section through the wheel housing of the forage harvester.

FIG. 4 illustrates a ground engaging device of the forage harvester in various positions in a schematic plan view.

### DETAILED DESCRIPTION

As discussed in the background, EP 1 518 453 B2 discloses a storage device for holding liquids or objects incorporated into the body of the agricultural work machine. However, there may hardly be any installation space available in the existing structures for the arrangement of a storage device due to the large number of required working units, and arranging a storage device on the outside of the forage harvester may lead to an overall increase in the structure or footprint of the forage harvester. For example, a reduced ground clearance of the forage harvester may be associated with an arrangement of the storage device at the bottom of the forage harvester.

Thus, in one or some embodiments, an apparatus is disclosed that may avoid extending the storage space for a functional assembly on an agricultural work machine without increasing the overall structure of the work machine.

In particular, in one or some embodiments, an agricultural work machine, such as a forage harvester, is disclosed that comprises: an axle body with at least one ground engaging device arranged or positioned on the axle body; at least one wheel housing which comprises a fender sectionally surrounding the ground engaging device radially on the outside and a side wall; and a storage space with a functional assembly located therein being arranged or positioned on the side wall.

Such an arrangement may have one or more advantages. The use of the installation space available in the wheel housing may make it possible to provide additional storage space without enlarging the overall structure of the agricultural working machine. Furthermore, a functional assembly arranged or positioned in the wheel housing is accessible in a particularly easy manner for maintenance work when the steering angle of the ground engaging device is turned.

In one or some embodiments, the functional assembly may be designed as a urea pump. An arrangement of the urea pump in the wheel housing may be particularly advantageous since, by moving the urea pump from the installation space in the agricultural working machine (e.g., within an interior of the agricultural working machine) into the wheel housing, installation space may be freed up in the agricultural working machine, which may be used for other purposes, such as to enlarge a fuel tank. Such a solution may be considerably more economical than an arrangement of the tank structure in the wheel housing.

In one or some embodiments, the fender may be designed at least sectionally as a urea tank. Due to the spatial proximity to the functional assembly (which may be designed as a urea pump), such an embodiment may be particularly advantageous.

In one or some embodiments, the functional assembly may be designed as a reservoir for storing a fluid.

In one or some embodiments, the axle body is designed as the rear axle of the work machine, wherein the rear axle is a steering axle. In this case, the functional assembly may be accessible in an easy manner for any maintenance work, such as without tools, when the ground engaging device is steered in (e.g., steered inward).

In one or some embodiments, the storage space may be surrounded by a cover, at least sectionally. In this case, the storage space may be limited by the cover. At the same time, the cover may serve to protect the functional assembly. In this case, the cover may be designed as a projection on the side wall. Furthermore, the cover may comprise a substantially convex section that extends axially in the vertical direction of the work machine and a section that tapers from an upper edge of the substantially convex section in the vertical direction towards the side wall.

In one or some embodiments, a mounting plate is arranged or positioned on the side wall, wherein the cover may be detachably arranged or positioned on the mounting plate, such as via a screw connection. Such a mounting plate may be particularly advantageous for the arrangement of the functional assembly. The detachable arrangement of the cover on the mounting plate may be particularly advantageous for maintenance work on the functional module.

In one or some embodiments, a main frame of the work machine may have a particularly stable structure so that an arrangement of the mounting plate on the main frame may be particularly advantageous. In one or some embodiments, the cover may be arranged or positioned above the axle body so that a downward swivel movement of the axle body is not limited by the cover.

In one or some embodiments, the cover may be arranged or positioned outside a surface that may be passed over by the ground engaging device during a steering maneuver so that a maximum adjustable steering angle is only spatially limited by the side wall. For example, the ground engaging device may include at least one extreme position that at least partly defines a maximum adjustable steering angle and the cover may be positioned outside the surface so that the at least partly defined maximum adjustable steering angle is spatially limited only by the side wall.

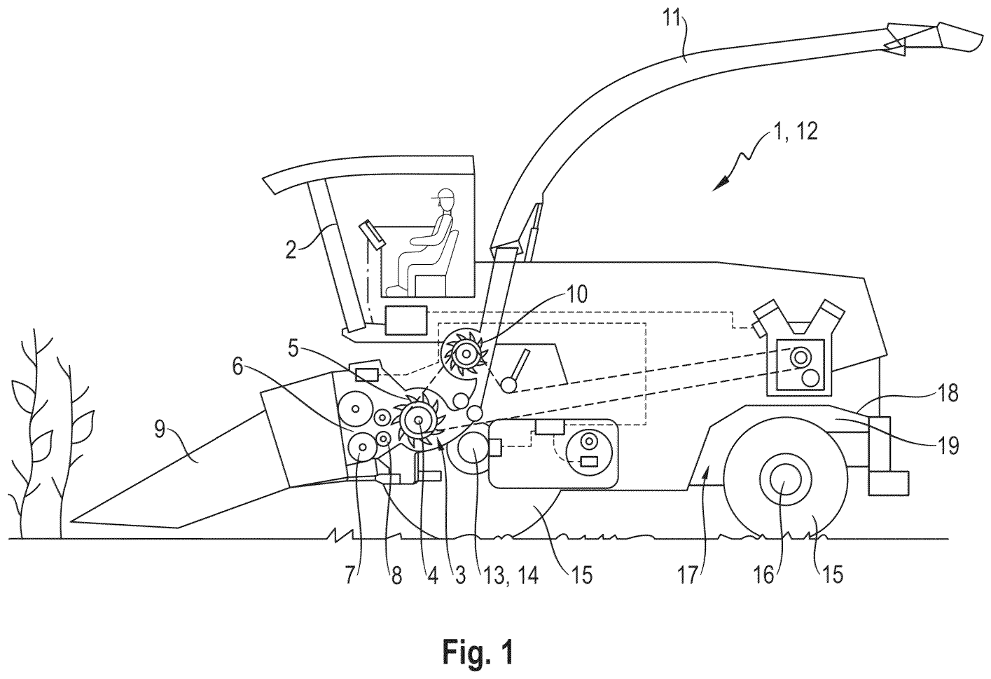

Referring to the figures, FIG. 1 illustrates a schematic and exemplary representation of an agricultural work machine 12 that may be designed as a forage harvester 1. Example forage harvesters include US Patent Application Publication No. 2022/0071091 A1 and US Patent Application Publication No. 2023/0232740 A1, each of which is incorporated by reference herein in their entirety. The chassis of the forage harvester 1 is shown cut away in its front part below a driver's cab 2 in order to be able to show internal assemblies or working units of the forage harvester 1 that are processing harvested material. One of these assemblies or working units may be a so-called cutterhead assembly 3 with a cutterhead 5 rotating around an axis of rotation 4 extending in the transverse direction of the vehicle.

A conveying device 6 for harvested material may be upstream from the cutterhead assembly 3. The conveying device 6 may comprise a plurality of roller pairs 7, 8 that each border a gap and are rotatably driven in opposite directions in order to feed the harvested material conveyed through the gap to the cutterhead 5.

The conveying device 6 may, in turn, bear a harvesting header 9 that may be exchanged to adapt to the harvested material to be picked up.

Harvested material comminuted in the cutterhead assembly 3 may be fed to a postaccelerator 10 that lends the comminuted harvested material the necessary speed to run through a discharge chute 11 and be transferred into an accompanying vehicle (not shown).

Front ground engaging device 15 may be arranged or positioned on an axle body 14 designed as a front axle 13. The rear ground engaging device 15 may be arranged or positioned on opposite sides of the forage harvester 1 on an axle body 14 designed as a rear axle 16. In one or some embodiments, the ground engaging device 15 (alternatively termed a soil engagement device) comprises one or more wheels, one or more tires (e.g., pneumatic tires or the like), one or more tracks (e.g., a crawler track or the like), or the like. In this regard, the ground engaging device may include all such components via which locomotion of the agricultural work machine on the ground is made possible. The rear axle 16 may be designed as the steering axle of the agricultural work machine 12.

In one or some embodiments, a ground engaging device 15 (arranged or positioned on the rear axle 16) is arranged or positioned in a wheel housing 17. The wheel housing 17 may comprise a fender 18 sectionally enclosing the ground engaging device 15 radially on the outside, and a side wall 19. The side wall 19 may be located behind the ground engaging device 15. The side wall 19 may extend substantially flat in a vertical direction.

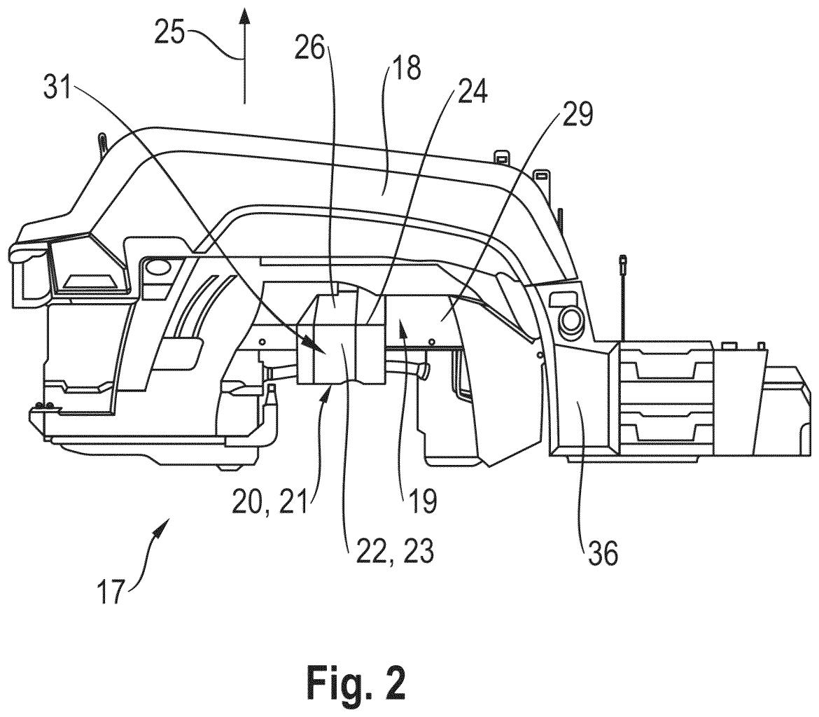

A side view of the wheel housing 17 is shown in more detail in FIG. 2. A storage space 20 with a functional assembly 21 located in the storage space 20 is arranged or positioned on the side wall 19 of the wheel housing 17.

The storage space 20 may be surrounded by a cover 22. The cover forms a projection 31 projecting from the side wall 19 in the axial direction of the axle body 14. The projection 31 and/or the cover 22 may be located above the axle body 14 designed as a rear axle 16. The cover 22 may spatially delimit the storage space 20. In so doing, the cover 22 may comprise (or consist of) a substantially convex section 23. The substantially convex section 23 may comprise (or consist of) a plurality of flat sections. In the axial direction, the substantially convex section 23 may extend in the vertical direction 25 of the forage harvester 1. The substantially convex section 23 may be open at the top, wherein a section 26 tapering towards the side wall 19 may be arranged or positioned at the upper edge 24 of the substantially convex section 23.

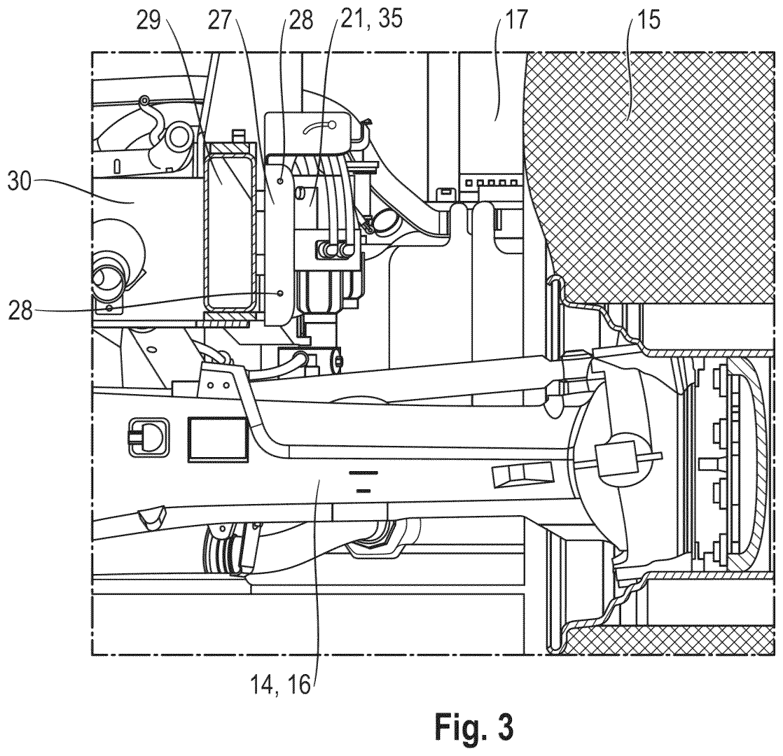

FIG. 3 shows a cross-section through the wheel housing 17. The cover 22 may be hidden in the view according to FIG. 3, so that a functional assembly 21 arranged or positioned in the storage space 20 formed by the cover 22 is visible. A mounting plate 27 may also be visible. The mounting plate 27 may be arranged or positioned on the side wall 19 of the wheel housing 17. The mounting plate 27 may be configured to hold or support the functional assembly 21 and/or the cover 22. The cover 22 may be detachably arranged or positioned on the mounting plate 27 using a screw connection. In one or some embodiments, the mounting plate 27 comprises a plurality of cutouts 28 for the screw connection.

In one or some embodiments, the side wall 19 is sectionally formed by a main frame 29. The main frame 29 may extend in the longitudinal direction of the agricultural work machine 12, wherein cross braces 30 are arranged or positioned on the main frame 29 for holding the front axle 13 and rear axle 16.

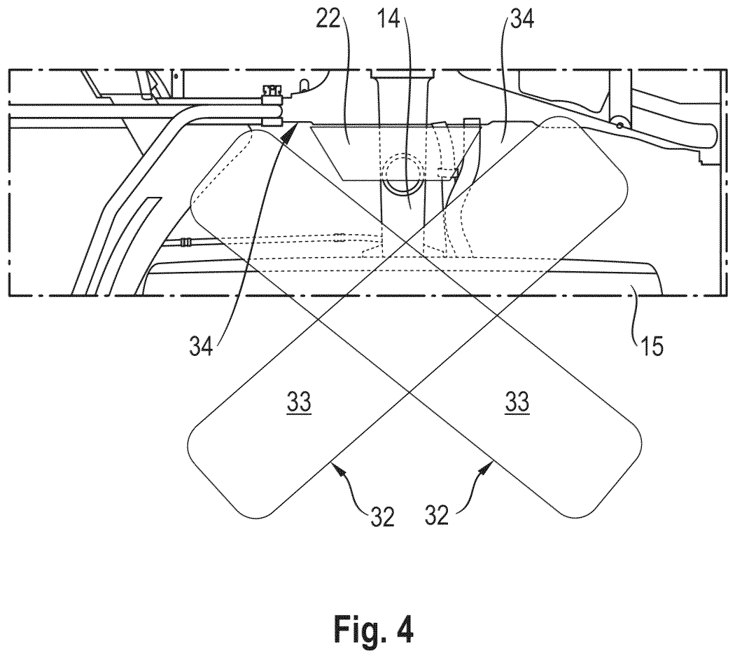

FIG. 4 shows a top view of the ground engaging device 15 with the axle body 14 and the cover 22. FIG. 4 also depicts two extreme positions 32 of the ground engaging device 15 which may represent the maximum adjustable steering angle.

The cover 22 may be arranged or positioned outside a surface 33 that may be reached or passed over during a steering operation of the ground engaging device 15. Consequently, the maximum adjustable steering angle may only be spatially limited by the side wall 19. The cover 22 forming the storage space 20 and the functional assembly 21 located in this storage space 20 may be arranged or positioned in an area 34 located between the extreme positions 32 of the ground engaging device 15 and the side wall 19.

In one or some embodiments, the functional assembly 21 is designed as a urea pump 35 shown in FIG. 3. An arrangement of the urea pump 35 in the area 34 may be particularly advantageous since, by moving the urea pump 35 from the installation space in the agricultural work machine 12 into the wheel housing 17, the installation space freed up in the agricultural work machine 12 may be used to enlarge a fuel tank. Such a solution may be considerably more economical than an arrangement of the tank structure in the wheel housing.

Nevertheless, in an alternative embodiment, the functional assembly 21 may also be designed as a reservoir, not shown here in detail, for storing a fluid, such as fuel or urea.

However, it may be particularly advantageous if, due to the spatial proximity, the functional assembly 21 is designed as a urea pump 35 and at the same time, as shown in FIG. 2, a urea tank 36 may be integrated into the fender 18.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

| | |
|---|---|
| 1 | Forage harvester |
| 2 | Driver's cab |
| 3 | Cutterhead assembly |
| 4 | Rotational axis |
| 5 | Cutterhead |
| 6 | Conveyor unit |
| 7 | Roller pair |
| 8 | Roller pair |
| 9 | Harvesting header |
| 10 | Postaccelerator |
| 11 | Discharge chute |
| 12 | Agricultural work machine |
| 13 | Front axle |
| 14 | Axle body |
| 15 | Ground engagement device |
| 16 | Rear axle |
| 17 | Wheel house |
| 18 | Fender |
| 19 | Side wall |
| 20 | Storage space |
| 21 | Functional assembly |
| 22 | Cover |
| 23 | Convex section |
| 24 | Edge |
| 25 | Vertical direction |
| 26 | Tapered section |
| 27 | Mounting plate |
| 28 | Cut-out |
| 29 | Main frame |
| 30 | Cross brace |
| 31 | Projection |
| 32 | Extreme position |
| 33 | Area |
| 34 | Area |
| 35 | Urea pump |
| 36 | Urea tank |

1. An agricultural work machine comprising:
an axle body with at least one ground engaging device positioned on the axle body;
at least one wheel housing comprising at least one fender sectionally surrounding the ground engaging device radially on an outside and a side wall; and
a storage space with a functional assembly located therein being positioned on the side wall.

2. The agricultural work machine of claim 1, wherein the agricultural work machine comprises a forage harvester.

3. The agricultural work machine of claim 1, wherein the functional assembly comprises a urea pump.

4. The agricultural work machine of claim 1, wherein the functional assembly comprises a reservoir configured to store a fluid.

5. The agricultural work machine of claim 1, wherein the at least one fender is designed at least sectionally as a urea tank.

6. The agricultural work machine of claim 1, wherein the axle body comprises a rear axle of the agricultural work machine.

7. The agricultural work machine of claim 6, wherein the rear axle comprises a steering axle.

8. The agricultural work machine of claim 1, wherein the storage space is surrounded at least sectionally by a cover.

9. The agricultural work machine of claim 8, wherein the cover forms a projection on the side wall.

10. The agricultural work machine of claim 9, wherein the cover comprises a substantially convex section that extends axially in a vertical direction of the agricultural work machine.

11. The agricultural work machine of claim 10, wherein the cover further comprises a section that tapers from an upper edge of the substantially convex section in the vertical direction towards the side wall.

12. The agricultural work machine of claim 11, further comprising a mounting plate positioned on the side wall; and
wherein the cover is detachably positioned on the mounting plate.

13. The agricultural work machine of claim 12, wherein the cover is detachably positioned on the mounting plate via a screw connection.

14. The agricultural work machine of claim 13, wherein the mounting plate is positioned on a main frame of the agricultural work machine.

15. The agricultural work machine of claim 9, further comprising a mounting plate positioned on the side wall; and
wherein the cover is detachably positioned on the mounting plate.

16. The agricultural work machine of claim 15, wherein the mounting plate is positioned on a main frame of the agricultural work machine.

17. The agricultural work machine of claim 16, wherein the cover is positioned above the axle body.

18. The agricultural work machine of claim 8, wherein the cover is positioned above the axle body.

19. The agricultural work machine of claim 8, wherein the cover is positioned outside a surface that is passed over by the ground engaging device during a steering operation.

20. The agricultural work machine of claim 19, wherein the ground engaging device includes at least one extreme position that at least partly defines a maximum adjustable steering angle; and
wherein the cover is positioned outside the surface so that the at least partly defined maximum adjustable steering angle is spatially limited only by the side wall.
